(19) United States
(12) Patent Application Publication
(10) Pub. No.: US 2014/0281500 A1
(43) Pub. Date: Sep. 18, 2014

(54) SYSTEMS, METHODS AND APPARATUSES FOR REMOTE ATTESTATION

(71) Applicant: OLogN Technologies AG, Triesen/FL (LI)

(72) Inventor: Sergey IGNATCHENKO, Innsbruck (AT)

(73) Assignee: OLogN Technologies AG, Triesen/FL (LI)

(21) Appl. No.: 14/205,042

(22) Filed: Mar. 11, 2014

Related U.S. Application Data
(60) Provisional application No. 61/788,326, filed on Mar. 15, 2013.

(51) Int. Cl. H04L 9/32

(52) U.S. Cl. CPC H04L 9/3263
USPC 713/156

(57) ABSTRACT

The systems, methods and apparatuses described herein provide a system for attesting a computing device. In one aspect, the computing device may comprise a secure zone configured to execute a task. The task may have executable code and data. The secure zone may be further configured to obtain a private key and an attestation certificate associated with the private key. The attestation certificate may be received from an attestation service attesting legitimacy of the computing device. The secure zone may be further configured to calculate a secure hash of the task, generate a message comprising the secure hash, sign the message with the private key and send the message and the attestation certificate to a second computing device in communication with the computing device.

### RELATED APPLICATIONS

This application claims priority to U.S. Provisional Application No. 61/788,326, filed Mar. 15, 2013, entitled “Systems, Methods and Apparatuses for Remote Attestation,” the content of which is incorporated herein by reference in its entirety.

### FIELD OF THE DISCLOSURE

The systems, methods and apparatuses described herein relate to data security and more particularly to techniques for remote attestation.

### BACKGROUND

Through remote attestation, an electronic device such as a computer, smartphone or tablet, may provide a remote entity such as a server, with information about the device such as, for example, the software or firmware currently running on the device. Known methods of remote attestation tend to either (a) ignore privacy completely, providing the same global identifier for a device to all software developers (which enables easy cross-referencing of a user's actions among different applications), or (b) concentrate on privacy to the detriment of other concerns by treating each instance of an application running on a device as a unique event (and, for example, preventing a subsequent instance of the application running on the device from realizing that it is being run on the same device as the first instance).

This second approach, while preserving privacy, has three significant drawbacks. First, it prevents application writers from addressing some legitimate needs. For example, application writers have a legitimate need to prevent their servers from being overburdened with registration requests. One current, but unreliable and annoying, method for addressing this concern is by employing “captchas.” Second, this approach prevents application writers from determining on their own whether the physical device on which the application is running has been compromised, and “blacklisting” the device based on the application writer's own determination. Third, depending on the specific implementation, this approach can either place a significant load on the central attestation service or, if “direct anonymous attestation” is used, may be based on less stringently scrutinized algorithms such as Camenisch-Lysyanskaya signatures and, therefore, deemed less secure than conventional algorithms such as the Rivest-Shamir-Adleman (RSA) algorithm.

### BRIEF DESCRIPTION OF THE DRAWINGS

FIG. 1 is a block diagram of an exemplary computing device according to the present disclosure.

FIG. 2 is a flow diagram of an exemplary method by which a system according to the current disclosure may accept a task for execution, organize the process of task execution, and cleanup after task execution.

FIG. 3 is a block diagram of an exemplary system according to the present disclosure.

FIG. 4A is a flow diagram of an exemplary process by which a computing device may acquire an anonymous attestation certificate (AAC).

FIGS. 4B-4D depict exemplary data structures that may be used in support of the method shown on FIG. 4A.

FIG. 5A is a flow diagram of an exemplary process by which a task running on a computing device can be attested once an AAC has already been obtained.

FIGS. 5B-5C depict exemplary data structures for messages that might be used in support of the process shown on FIG. 5A.

FIG. 6A is a flow diagram of an exemplary process by which a computing device may acquire an AAC.

FIGS. 6B-6D depict exemplary data structures that may be used in support of the process shown on FIG. 6A.

FIG. 7A is a flow diagram of an exemplary process by which two computing devices in a peer to peer relationship may attest one another.

FIG. 7B is a block diagram of a system for accomplishing peer to peer attestation.

FIG. 7C depicts an exemplary data structure that may be used in support of the process shown in FIG. 7A.

FIG. 8A is a flow diagram of an exemplary process by which one computing device may report another computing device as potentially compromised.

FIG. 8B depicts an exemplary data structure that may be used in support of the process shown in FIG. 8A.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

U.S. Provisional Patent Application No. 61/623,861, entitled “Secure Zone for Digital Communications,” and filed on Apr. 13, 2012, the entirety of which is hereby incorporated by reference, discloses a hardware platform to implement security solutions that are not susceptible to software-based attacks. The systems, methods and apparatuses described therein provide a way to transfer certain activities to a secure zone within a computing device which cannot be compromised even if the operating system is under complete control of an attacker. For additional security, the secure zone disclosed therein may be made tamper-resistant and/or may use tamper detection techniques with, for example, erasure of one or more cryptographic keys upon tamper detection.

The inventions disclosed in the present application provide additional systems, methods and apparatuses that permit the remote attestation of a computing device having a secure zone, as well as the remote attestation of applications, code, tasks, or other routines running within that secure zone, wherein such remote attestation is based on robustly tested algorithms and without reliance on global identifiers.

The present disclosure provides systems, methods and apparatuses for remote attestation that allow remote entities to obtain reasonable device (and/or application) identification while preserving privacy by limiting the information available to a party or entity (e.g., a server) to that information which is legitimately needed by that party or entity. For example, embodiments according to the present disclosure may ensure that any device identifier provided to application developers should not allow an entity to cross-reference information between application developers. Additionally, exemplary methods and apparatuses are provided to allow application developers to determine that a physical device has been compromised and allow the application developers to “blacklist” the device while still preserving privacy.

FIG. 1 shows one example by which a secure zone 150 may be implemented in a computing device 120, such as a computer, laptop, smart phone, smart television set, set-top box, etc. As shown in FIG. 1, a secure zone 150 may comprise an interface 151 to one or more non-secure zones 152. The term “non-secure zone,” as used herein, refers to any device, processor, other object, operating system, or application, or combination thereof, that is capable of providing messages, codes, tasks or other information to a secure zone 150. For example, in the exemplary embodiment shown on FIG. 1, the non-secure zone 152 may comprise an operating system 111 and one or more applications 112. The interface 151 may be configured to receive these messages, codes or tasks from the non-secure zone 152. For example, if a secure zone 150 is implemented in a laptop, the interface 151 may be implemented as some kind of bus (for example, a PCIe bus) and may be configured to receive messages, executable code, tasks or other information from the laptop's central processing unit. If the secure zone 150 were implemented in a television, the interface 151 again might be implemented, for example, as some kind of bus (for example, an I²C bus), and configured to receive messages, executable code, tasks or other information from a separate set-top box or from the microcontroller unit of the television.

A secure zone 150 may further comprise a supervisor 160 coupled to the interface 151. The supervisor 160 may be used to control access to the components of the secure zone 150, and may be used to enforce certain operational rules of the secure zone 150 to provide certain security assurances to the end-user. For example, in one embodiment, the supervisor 160 may be configured to: (1) receive a task or executable code that can be run on one or more processors 162 within the secure zone 150; (2) verify any digital certificates associated with this task or code; (3) if one or more predetermined requirements are fulfilled, instruct a processor 162 within the secure zone 150 to execute the task or code; and/or (4) clean up (to the extent required) after the task or code has been executed. In one embodiment, the supervisor 160 may be implemented in hardware within the secure zone 151, such that the supervisor 160 cannot be affected or modified.

For example, the supervisor 160 may be configured to fulfill one or more tasks as described in U.S. Provisional Application No. 61/623,861 (previously mentioned) or U.S. Provisional Patent Application No. 61/636,201, entitled “Improved Secure Zone for Secure Purchases,” and filed on Apr. 20, 2012, the entirety of which is incorporated herein by reference.

In general, code or application refers to a set of instructions that may be executed on a computing device whereas task refers to the combination of the executable code and associated data that may be operated on by the secure zone. Throughout this disclosure, the terms task, code, executable code, or other similar terms may be used interchangeably to refer to any executable set of instructions (and, as appropriate, any associated data). Those with ordinary skill in the art recognize that, depending on the situation and context, the secure zone may execute code that has no associated data. Thus, references to code are not intended to imply that data is necessarily excluded, and references to tasks are not intended to imply that data is necessarily included.

Additionally, the supervisor 160 may be configured to obtain and/or process one or more anonymous attestation certificates (AACs) from a third-party attestation service. The supervisor 160 may be further configured to use one or more AACs for the purpose of assuring a remote server (or other remote entity) with which the computing device 120 is communicating that (1) the computing device 120 has a legitimate secure zone 150 (rather than, for example, a software emulator emulating a secure zone), and/or (2) that the secure zone 150 is not known to be compromised at the time the AAC is issued. Exemplary processes for acquiring an AAC and for using an AAC to attest secure zones (or particular tasks running within a secure zone) are described herein.

The secure zone 150 may also comprise a secure processor 162, an instruction memory 164 and a data memory 165. The secure processor 162 may be configured to execute code loaded into the instruction memory 164 and to exchange data with the non-secure zone 152 through the interface 151. The secure processor 162 may be a general purpose processor or any suitable form of special purpose processor. In some embodiments, the secure processor 162 may be implemented as hardware separate from the supervisor 160; in some other embodiments, the supervisor 160 and the secure processor 162 may be implemented using the same hardware. In addition, it will be understood that while FIG. 1 shows the secure processor 162 as having a so-called “Harvard architecture” (with separate instruction memory 164 and data memory 165), other architectures (like the ubiquitous von Neumann architecture) may be used as long as equivalent instruction and data restrictions are enforced by the supervisor 160. By way of example and not limitation, the XN bit may be used in ARM® processors to provide some separation of data memory from instruction memory, as long as the XN bit in appropriate memory areas is enforced by the supervisor 160 and cannot be altered by code running within the secure zone 150. Similar separation may be achieved on x86 architecture by using the NX bit (also known as the XD bit on INTEL® CPUs and as Enhanced Virus Protection on AMD® CPUs).

In certain embodiments, the secure zone 150 may further comprise one or more cryptographic engines represented by a cryptographic engine 121 shown in FIG. 1. The cryptographic engine 121 may be used by the supervisor 160, among other things, in support of digital certificate verification. The cryptographic engine 121 may be configured to implement one or more symmetric and/or asymmetric cryptographic algorithms, such as Advances Encryption Standard (AES) algorithm, the RSA algorithm or any other existing or future-developed cryptographic algorithm. The cryptographic engine 121 may receive data from the supervisor 160 for encryption or decryption, and may provide the resulting ciphertext (or plaintext, as appropriate) back to the supervisor 160. The secure zone 150 may also comprise a random number generator (RNG) 124 to provide support to cryptographic processes. In other embodiments, the supervisor 160 may be configured to perform some or all of the functionality of the cryptographic engine 121 and/or random number generator 124, and a separate cryptographic engine 121 or RNG 124 may not be required.

In some embodiments, the instruction memory 164 and data memory 165 may be implemented as volatile memory. The absence of persistent writable storage for executable code may ensure that no viruses, back-doors, or other malicious code may be installed within the secure zone 150. In addition, the secure zone 150 may contain one or more certificate storages, represented by a certificate storage 166 shown in FIG. 1, which may be implemented as read-only, non-volatile memory. The certificate storage 166 may store one or more root certificates of one or more Certification Authorities (CA), which, in turn, may be used for certificate validation.

The secure zone 150 may additionally comprise one or more key storages represented by a key storage 167 in FIG. 1. The key storage 167 may be implemented, for example, as non-volatile memory and may be used, for example, for the storage of one or more private keys (which can be generated, for example, by the supervisor 160 using RNG 124), one or more corresponding public key(s), and/or a unique device identifier. This information may be used, among other uses, to identify and/or authenticate the secure zone 150.

The secure zone 150 may further comprise one or more AAC storages, represented by an AAC storage 168 in FIG. 1. The AAC storage 168 may be implemented, for example, as a non-volatile memory and may be used to store one or more AACs which can be used to reliably attest the secure zone 150. The process by which AACs may be acquired and used for task attestation is described in greater detail herein.

In addition, the secure zone 150 may include a timer 169, which may be used, for example, to determine whether time restricted certificates and AACs remain valid. One exemplary implementation of a secure timer 169 is described in U.S. Provisional Patent Application No. 61/661,248, entitled “Systems, Methods and Apparatuses for Secure Time Management,” and filed on Jun. 18, 2012, the entirety of which is hereby incorporated by reference.

The secure zone 150 may be physically secured, such that it is tamper-resistant. The secure zone 150 may also (alternatively, or in addition to being tamper-resistant) incorporate one or more tamper detection techniques. For example, several tamper-resistant methods for protecting cryptographic processors are already known and have been described in the art; see http://www.cl.cam.ac.uk/techreports/UCAM-CL-TR-641.pdf. In some embodiments, it may be desirable, for example, to manufacture the secure zone 150 within a single chip. In another embodiment, the secure zone 150 might have a secure enclosure. In some of these embodiments, the secure zone 150 may be configured to execute one or more possible responses if it detects that the chip's integrity has been compromised, and/or if it detects penetration of the secure enclosure. These responses may vary from erasing sensitive data to the physical destruction of all or part of the secure zone 150.

FIG. 2 shows an exemplary method by which a secure zone 150 according to the present disclosure may accept a task for execution, organize the process of task execution, and cleanup after task execution. At step 205, the interface 151 may receive the task from the non-secure zone 152, and may pass this task to the supervisor 160 for execution by the secure processor 162.

At step 210, prior to executing the received task, the supervisor 160 may clear all data stored within the instruction memory 164 and data memory 165. For example, the supervisor 160 might zero all of the instruction memory 164 and data memory 165. This may be performed to prevent old code, data, or both, from affecting the task currently being loaded, and to avoid information leaks between different tasks.

The task (code and/or any related data) may have been digitally signed using the task signer's private key, guaranteeing the authenticity of the task. The task signer refers to the entity that has digitally signed the task or executable code that is loaded into the secure zone 150. To enable validation of the digital signature and the signed code, a digital certificate capable of authenticating the task signer may be provided with the code. For example, the task signer may have a private key and a corresponding digital certificate which has been signed by a “root certificate” of a certificate authority (CA). In such an implementation, the root certificate of the CA previously may have been stored in the certificate storage 166. In some embodiments, instead of a single certificate, whole “certificate chains” may be included with the code. In other embodiments, alternative ways of obtaining intermediate certificates (for example, issuing a request to a server (not shown) via the operating system 111 and communications port 118) may be used. In some embodiments, a task certificate may also include additional information; for example, a list of remote servers with which the task is permitted to communicate.

At step 220, the supervisor 160 may use the cryptographic engine 121 to validate the digital signature of the task signer. This validation of the digital signature may include validation of the certificate received with the task. For example, if the task signer's certificate is signed by a certificate authority such as VERISIGN®, the supervisor 160 may take a copy of the appropriate VeriSign root certificate from the certificate storage 166 and verify that this root certificate was used to sign the task signer's certificate, performing a typical public key infrastructure (PKI) signature validation. In some cases, a more elaborate validation (including, for example, certificate chains) may be implemented. In some embodiments, other signature validation schemas (for example, those used in the simple public key infrastructure (SPKI), simple distributed security infrastructure (SDSI) or the “web of trust” used in pretty good privacy (PGP)) may be used.

In some embodiments, at step 220, the supervisor 160 may additionally perform certificate revocation list (CRL) validation to ensure that all certificates involved in the signature validation are still valid. A CRL can be obtained, for example, by means of a request to a server which hosts CRLs. This request can be made, for example, via the operating system 111 and the communications port 118 of the non-secure zone 152. In some embodiments, the Online Certificate Status Protocol (OCSP) may be used to check certificate validity (instead of or in addition to CRL validation).

At step 245, the supervisor 160 may load the code associated with the received task into the instruction memory 164, may store any received application data into the data memory 165, and may instruct the secure processor 162 to begin executing the received code.

At step 250, the supervisor 160 may begin waiting for one or more events related to code execution of the task. In some embodiments it may happen that, as shown at transition 260, the code running on the secure processor 162 requests a secure connection with a specific remote server.

In this case, at step 270, the supervisor 160 may establish a secure connection with a server and pass the secure connection to the task. For example, the supervisor 160 may first verify that the task is allowed to establish a connection with this server by inspecting the list of servers with which the task is allowed to establish a connection. In one embodiment, the list of allowed servers may be included in the task certificate as described above. As part of establishing a secure connection, the supervisor 160 may verify the remote server's certificate before permitting the task to send and/or receive data over this connection. The secure connection may be, for example, a secure sockets layer/transport layer security (SSL/TLS) connection. It is also to be understood that in establishing this secure connection, the supervisor 160 may in part utilize a communication stack running in the non-secure zone 152 and/or physical hardware that is located in the non-secure zone 152. The supervisor may then return to step 250 and await a task related event. In some embodiments, the communication stack running in the non-secure zone 152 may include, for example, a TCP/IP stack.

If, at transition 255, the task has finished executing, the task may send a notification back to the supervisor 160 notifying it that code execution has finished, and the supervisor 160 may perform certain steps to transition control back to the non-secure zone 152. At step 275, the supervisor 160 may begin a “cleanup” routine and clear all the instruction and data memories 164 and 165 (for example, by zeroing them).

FIG. 3 shows one exemplary embodiment of a system in which a secure zone 150, a task running within the secure zone 150, or both, can be remotely attested. As shown on FIG. 3, such an exemplary system may comprise a computing device 120, a server 300 and an attestation service 330. The computing device 120 may be an embodiment of the computing device 120 of FIG. 1 (although only some of the components are shown in FIG. 3 for simplicity). The server 300 may be any server with which a task running in the secure zone 150 may communicate. By way of example and not limitation, the server 300 may be operated by a financial institution such as a bank that wants to ensure that payment information is accepted from (or provided to) authenticated users that are running an attested task on an attested device. The server 300 may be connected to the computing device 120 by one or more communications links, shown on FIG. 3 as the communication link 305. This communication link 305 may be any form of wired or wireless connection, including but not limited to Ethernet, LAN, WAN, the Internet, 3G, 4G or 4G LTE, as appropriate in view of the overall system requirements.

The server 300 may run one or more software programs or other services (not shown) that require attestation of the secure zone 150 of the device 120. In such an example, the server 300 may require assurance that (a) the computing device 120 has a secure zone 150 that implements a legitimate supervisor 160 (and not, for example, a software emulator of such a secure zone running on device 120), (b) the code currently running in the secure zone 150 can be trusted by the server 300 as having come from a legitimate (and identifiable) task signer, and/or (c) the code currently running in the secure zone belongs to a predefined set of trusted codes (wherein each such trusted code may be identified, for example, by its secure hash).

The attestation service 330 may be configured to provide certain information in support of the attestation of a secure zone 150. The attestation service 330 may be connected to the computing device 120 by one or more communications links, shown on FIG. 3 as the communication link 306. This communication link 306 may be any form of wired or wireless connection, including but not limited to Ethernet, LAN, WAN, the Internet, 3G, 4G or 4G LTE, as appropriate in view of the overall system requirements.

As shown in FIG. 3, the attestation service 330 may comprise a database 303, which may contain one or more device identifiers 310 and one or more public keys 307a corresponding to one or more secure zones 150. The corresponding private key 307b may be stored within the secure zone 150 of the computing device 120. In some embodiments, the public key 307a may also serve as the device identifier such that a separate device identifier 310 may not be necessary.

In one embodiment, it may be assumed that if a device public key 307a and/or device identifier 310 have been stored within the database 303 then the corresponding secure zone 150 is legitimate and non-compromised (e.g., not a software emulator running on a computing device 120). In such embodiments, the database 303 may be secured and/or access restricted so that only authorized individuals or entities may update or modify its records. For example, one method by which the database 303 may be populated with device identifiers 310 and public keys 307a is when the secure zones 150 are manufactured within a secure facility. It will be understood, however, that any suitable method of populating these values within the database 303 may be used.

For simplicity of explanation throughout, the terminology used is “device identifier” 310 and “device public key” 307a. However, in certain embodiments, to enhance privacy for example, the secure zone 150 may not have a device identifier 310 and/or a device public key 307a that are the same across attestation services and/or tasks. In such embodiments, the secure zone 150 may use a different attestation service-specific identifier 310 and attestation service-specific public key 307a for each different attestation service 330. U.S. Provisional Patent Application No. 61/664,465, entitled “Systems, Methods and Apparatuses for the Application-Specific Identification of Devices,” and filed on Jun. 26, 2012 (the entirety of which is incorporated herein by reference), discloses exemplary methods, systems and apparatuses for implementing device- and application-specific identifiers and keys. Using the techniques described in the 61/664,465 provisional patent application, for example, the secure zone 150 according to the present disclosure may generate or have different public keys 307a and/or different device identifiers 310 for different attestation services 330. In other words, rather than each attestation service 330 storing one global device identifier and one global public key for each secure zone 150, each different attestation service 330 may store its own unique attestation service-specific device identifiers and public keys for each secure zone 150. For example, in a system comprising two different attestation services 330 (each belonging to different entities and having different digital certificates), each attestation service 330 would have its own database 303, and the device identifiers 310 and public keys 307a in each database 303—referencing the same physical secure zone 150—may be different. While this approach would minimize or eliminate the privacy risks associated with the ability to cross-reference identifiers among different attestation services, it may nevertheless be appropriate or acceptable in certain embodiments to use a global public key 307a and global device identifier 310 to reduce complexity and maintenance costs.

Each attestation service 330 may store within memory 331 one or more sets of asymmetric keys. The memory 331 may be implemented, for example, as a non-volatile memory, such as a hard disk drive, a solid state drive, etc. In some embodiments, the attestation service 330 may comprise a first “communications” key pair 332a/b designed to ensure the privacy of messages sent to the attestation service 330. This communications key pair 332a/b has been abbreviated as Kpasp 332a (public) and Ksasp 332b (private) throughout. For example, messages intended to be securely sent to the attestation service 330, such that only the attestation service 330 may decrypt those messages, may be encrypted using Kpasp 332a as described in greater detail herein.

Each attestation service 330 may further comprise a second “attestation” key pair 333a/b, which may be used to digitally sign AACs generated by the attestation service 330. This attestation key pair 333a/b has been abbreviated as Kpasa 333a (public) and Ksasa 333b (private) throughout. For example, AACs generated by the attestation service 330 may be digitally signed using Ksasa 333b and validated using Kpasa 333a as described in greater detail herein.

In some embodiments, the key pairs may have different key sizes. For example, the communications key pair 332a/b may have a 1024-bit key length, while the attestation key pair 333a/b may have a 2048-bit key length. In other embodiments, the key pairs may have the same key size. In one embodiment, the same key pair may be used as both the communications and attestation key pairs.

In some embodiments (for example as discussed with respect to FIGS. 6A-6D), the database 303 may further store, in addition to the device identifier 310 and public key 307a, for each secure zone 150: (i) a current temporary device identifier 350 and an associated secret key 355; and (ii) a new temporary device identifier 360 and an associated secret key 365, which are described further herein.

As noted above, the server 300 communicating with the computing device 120 may require assurance that it is communicating with a legitimate and trustworthy secure zone 150 of the device 120. FIG. 4A shows one exemplary process for a secure zone 150 to obtain an AAC from an attestation service 330. The process may involve a method implemented by the secure zone 150 and a method implemented by the attestation service 330. The existence of an AAC for a particular secure zone 150 may be used as evidence of the secure zone's trustworthiness. Additionally, the AAC may be used, as described in greater detail below with respect to FIG. 5A, to attest a specific task (or tasks from a specific task signer) running within the secure zone 150. FIGS. 4B-4D depict exemplary data structures for the messages that may be communicated in the process of requesting an AAC from an attestation service 330.

The exemplary process to obtain the AAC may start at block 400, at which the method implemented by the secure zone 150 may start. At block 400, a device attestation descriptor may be obtained by a supervisor 160. One exemplary device attestation descriptor 470 is shown in FIG. 4B. By way of example and not limitation, the device attestation descriptor 470 may be received from a task while it is running within the secure zone 150. For example, the device attestation descriptor 470 may be received at the same time that the task is loaded into the secure zone 150, or it may be requested and/or received in any other appropriate manner or time. In some embodiments, the device attestation descriptor 470 may be received from a server 300, for example, as part of an attestation process. Regardless of how the device attestation descriptor is received, the supervisor 160 may also know the task signer with which the attestation descriptor is associated.

The device attestation descriptor 470 may comprise one or more digital certificate of a suitable attestation service 330 (referred to herein as “Cas” 472) that may be used to perform device attestation. The Cas 472 may comprise an attestation service identifier 473, which may be used to determine which attestation service 330 should be used for attestation. For example, the identifier 473 may comprise or reference a URL of the attestation service. In embodiments in which a descriptor 470 includes more than one Cas 472, it may be desirable to, for example, require that at least N services (i.e., a subset greater than one of the services identified in the descriptor 470) attest the secure zone 150. In some embodiments, the Cas 472 may be signed by a CA recognized by the secure zone 150.

In some embodiments, the Cas 472 may contain an additional flag (not shown) indicating that the certificate was issued to a legitimate attestation service. In other embodiments the Cas 472 may be validated using a specially designated root certificate, which may be stored, for example, within certificate storage 166 of the secure zone 150 and used to validate the digital certificates of attestation services.

Additionally, in some embodiments, the device attestation descriptor 470 may comprise an additional digital certificate (not shown) issued, for example, by the attestation service 330, certifying that tasks signed by specific task signers are allowed to use this specific attestation service 330. In such embodiments, the supervisor 160 may deny attestation requests by tasks signed by task signers that are not included in the additional digital certificate. Such an embodiment may be useful, for example, in implementations in which the attestation service may want to charge task signers for its attestation services.

At block 405, the supervisor 160 may validate the Cas 472 contained within the device attestation description 470 using, for example, a root certificate previously stored within the supervisor 160 or certificate storage 166. In embodiments having the additional flag noted above, this validation of the Cas 472 may include checking this flag (or validating the certificate against the different root certificate) to ensure that only certified attestation services are being used. In embodiments wherein the device attestation descriptor 470 further comprises an additional digital certificate certifying the task's authorization to use the specific attestation service 330, the supervisor 160 may validate this additional certificate before proceeding.

If the received Cas 472 is validated, at block 410, the supervisor 160 may check whether a valid AAC that attests the secure zone 150 and is associated with the task signer of the task currently running in the secure zone 150 is already stored within AAC storage 168. If such a valid AAC is already stored in the AAC storage 168, the method may proceed to block 460. If an appropriate AAC is not located within AAC storage 168, the supervisor 160 may need to obtain an AAC from an attestation service 330.

To request an AAC from an attestation service 330, at block 415, the supervisor 160 (in conjunction with, in some embodiments, the RNG 124) may generate (i) an asymmetric key pair, Kpaa/Ksaa 476a/b associated with the task signer of the task currently running in the secure zone, and (ii) an AAC request 474 (FIG. 4C). In some embodiments, an asymmetric key pair 476a/b associated with the task signer of the task currently running in the secure zone may already have been generated and stored (e.g., in the AAC storage 168). In that event, the public key Kpaa 476a may be retrieved from storage and used instead of generating a new key pair. As shown in FIG. 4C, the AAC request 474 may comprise the public key Kpaa 476a of key pair 476a/b. This key pair may be used, as described in greater detail herein, to reliably authenticate a supervisor 160 bearing an AAC as a secure physical device. The AAC request 474 may further comprise the device identifier 310.

In some embodiments, to mitigate the potential for denial-of-service (DoS) attacks, the AAC request 474 may contain a current time 478 (e.g., provided by timer 169), which may be digitally signed using a private key 307b of the secure zone 150 (this digital signature shown as field 480 on FIG. 4C). It will be understood that in embodiments wherein the secure zone 150 does not have global identifiers 310 and key pairs 307a, but rather has attestation service-specific device identifiers and key pairs, the private key used to sign the time 478 may be an attestation service-specific private key of the device. This attestation service-specific private key may be identified within key storage 167 using, for example, attestation service identifier 473 included in the Cas 472.

In certain embodiments, the entire AAC request 474 may further be encrypted using a public key of the attestation service 330, e.g., Kpasp 332a, so as to ensure that only the attestation service 330 can read or otherwise extract information from the request 474. This public key Kpasp 332a may be obtained from, for example, the Cas 472. At block 420, the supervisor 160 may send the AAC request 474 to the attestation service 330. The method implemented by the secure zone 150 for obtaining the AAC may thereafter await a response.

To further mitigate the potential of DoS attacks, the supervisor 160, the attestation service 330, or both, may impose a limit on the rate of AAC requests 474. For example, such a limit may be one request per attestation service 330 per 10 seconds for each supervisor 160. If this rate limit is exceeded by a supervisor 160, the attestation service 330 may assume that the corresponding secure zone 150 has been compromised and remove it from the list of secure zones 150 stored within database 303.

At block 430, the method implemented by an attestation service 330 may start, at which the attestation service 330 may receive and decrypt the AAC request 474 using its private key Ksasp 332b. At block 435, the attestation service 330 may locate the appropriate public key 307a for the requesting secure zone 150. For example, the attestation service 330 may use the device identifier 310 within the AAC request 474 to find the corresponding public key 307a within the database 303. At block 440, the attestation service 330 may validate the time 478 contained within the AAC request 474. For example, the attestation service 330 may require that the time 478 be within a predefined range of the time kept by the attestation service's timer 308. The attestation service 330 may also validate the digital signature 480 associated with the time 478 using the device public key 307a acquired at block 435.

If the appropriate public key 307a is not found in the database 303 at block 435, or any of the validations at block 440 fail, the attestation service 330 may not provide an AAC to the secure zone 150 and, in certain embodiments, may further return an error message to the supervisor 160. Furthermore, if the digital signature 480 of the secure zone 150 is valid, but the rate limit for AAC requests (discussed above) is exceeded by a secure zone 150, in certain embodiments the attestation service 330 may assume that the secure zone 150 has been compromised and remove it from the list of secure zones 150 within the database 303.

If, however, blocks 435 and 440 complete successfully, at block 445, the attestation service 330 may create an AAC 484 (FIG. 4D) comprising: (i) Kpaa 476a (as generated at block 420 and provided in the AAC request 474), (ii) an AAC validity period 486, i.e., the period of time during which the AAC 484 is considered valid, which may be specified, for example, as “not before” and “not after” fields, and may have any duration (e.g., five minutes, one year or some other duration), and/or (iii) a digital signature 488, signing both Kpaa 476a and the AAC validity period 486, using Ksasa 333b. In some embodiments, the AAC validity period 486 may be omitted or may be set such that there is no time limit to the validity of the certificate. In some embodiments the attestation service 330 may also add to the AAC the attestation service identifier 473, which may later be used in the process of AAC signature validation. The existence of an AAC 484 may be used to indicate that whoever has the private key corresponding to Kpaa 476a (i.e., whoever holds Ksaa 476b) is a legitimate and non-compromised secure zone 150.

When the AAC 484 is created at block 445, it may be encrypted using the device public key 307a to ensure that it can be decrypted and accessed only by the appropriate supervisor 160 (which controls the corresponding private key 307b). At block 448 the AAC may be stored in association with the device identifier 310 within the database 303 and, at block 450, the AAC 484 may be sent back to the supervisor 160. The information stored at block 448 may further be used to determine and/or specify which secure zones 150 have been compromised and should no longer be trusted as described, for example, in more detail with respect to FIG. 8. The method implemented by the attestation service 330 may end when the block 450 is completed.

On receipt of the encrypted AAC 484, the method implemented by the secure zone 150 may resume. At block 455, the supervisor 160 may receive the encrypted AAC 484 and decrypt the AAC 484 using the device private key 307b, and may store in AAC storage 168: (i) a task signer identifier which identifies the task signer with which the AAC is associated; (ii) the attestation service identifier 473; (iii) the AAC 484; and (iv) Ksaa 476b (the private key generated at block 420 and associated with this particular AAC 484). In this manner the AAC is associated with a specific task signer which protects privacy, for example, by preventing cross-referencing of AACs between task signers. Accordingly, the same secure zone 150 may store a different AAC for each task signer, and the supervisor 160 should not present or use an AAC that is associated with one task signer to another task signer.

At block 460, the supervisor 160 may notify the task that it has an AAC 484 that is associated with the task's task signer.

Instead of associating AACs with a particular task signer, the supervisor may instead associate an AAC with a list of servers with which tasks may be allowed to communicate (thus allowing tasks of different signers to share the same AAC while communicating with those servers), or with both the task signer and a list of servers (thus requiring different AACs for tasks of the same code signer, which may connect to servers from different lists).

As noted above, the duration of the validity period 486 of the AAC 484 may vary. For example, in some embodiments the duration of the validity period 486 may be set to as little as 5 minutes, while in other embodiments it may be as long as one year. It will be understood that if a relatively large duration is selected for AAC validity period 486 (such as one year), it may be desirable for the attestation service 330 to publish one or more certificate revocation lists (CRLs) with respect to its issued AACs 484. For example, the attestation service 330 may publish a CRL once per day with a 2-day CRL validity period. It will be understood that to maintain security, it may be desirable to allow the distribution of such CRLs (signed, for example, by Ksasa 333b), only as a whole, without allowing per-certificate requests (using a protocol such as OCSP), because such per-certificate requests could allow the attestation service 330 to associate a specific AAC 484 with the requesting server 300, and as the attestation service 330 already “knows” the association of the AAC 484 with the secure zone 150, there is a possibility that the requestor could be associated with the secure zone 150, which may negatively impact privacy and/or security.

In some embodiments it may be advantageous to request one or more AACs in advance and to store them within AAC storage 168 but not associate them with a specific task signer. When a task requires attestation, one of the already stored AACs may be marked as associated with the task signer and used for attestation. It should be understood, however, that because the validity of AACs may be time limited, it may be impractical to acquire too many AACs in advance. Also it should be understood that, once used to attest a task signed by a particular task signer, the same AAC should not be used to attest a task signed by a different task signer.

In some embodiments, upon completion of the process described with respect to FIG. 4A, the supervisor 160 of a computing device 120 may possess an AAC 484 that attests the secure zone 150 and is further uniquely associated with a specific task signer. In other words, that particular AAC 484 may not be used by supervisor 160 with respect to tasks signed by any other task signers, to identify the secure zone 150 and a task running in it. Attestation of a task is possible because if a server 300 in communication with the computing device 120 accepts the AAC 484 as proof that the secure zone 150 is legitimate, then it may accept any information coming from the secure zone 150 about a task currently running within it as legitimate information as well. The server 300 may then decide, based on that information, whether the task itself is a trustworthy task.

FIG. 5A shows an exemplary process by which a secure zone 150 of a specific computing device 120, and a specific task running in the secure zone 150, may be attested as trustworthy once an AAC 484 has been obtained for the secure zone 150. FIGS. 5B-5C depict exemplary data structures for messages that might be used in support of the method shown in FIG. 5A. The process shown in FIG. 5A may involve a method implemented by the secure zone 150 and a method implemented by the server 300.

At block 500, a secure communication channel between the secure zone 150 and the server 300 may be established across the communications link 305. In some embodiments, this connection may be, for example, an SSL/TLS connection using server certificate, which ensures that the connection is established with a known entity. The methods implemented by the secure zone 150 and server 300 respectively may both start at the block 500 to establish the secure channel. For example, the supervisor 160 may in part or in whole use hardware and software in the non-secure zone to establish the connection. In some embodiments, the supervisor 160 may first validate that the server with which the connection is to be established is one with which the task running in the secure zone 150 is authorized to communicate. For example, the supervisor 160 may validate that the server certificate is listed within a specially designated field of the task signer certificate (wherein such a field may have semantics that identify the entities with which tasks signed by this particular task signer may communicate), or task certificate. In other embodiments, this connection may be, for example, an SSL/TLS connection using an anonymous Diffie-Hellman key exchange (if, for example, no credentials of either device have been presented yet). It is to be understood, however, that any suitable method of key exchange may be used. Embodiments with anonymous key exchange, however, may be open to man-in-the-middle attacks and, therefore, may not always be acceptable for security reasons. In the exemplary embodiment shown in FIG. 5A, it is assumed that all subsequent communications between the task and the server 300 use this secure channel with a known server.

At block 505, the method implemented by the server 300 may continue, at which the server 300 may send to the supervisor 160, via the secure channel, an attestation request 570 (FIG. 5B), through which the server 300 may request that the supervisor 160 provide attestation that the secure zone 150 is legitimate and uncompromised (and, optionally, that a specific task is running inside the secure zone 150). In some embodiments, as shown on FIG. 5B, the task attestation request 570 may comprise a nonce 572, which may be generated by the server 300. The method implemented by the server 300 may thereafter await for a response.

At block 510, the method implemented by the secure zone 150 may continue, at which the supervisor 160 may receive the task attestation request 570 and create the task attestation response 580 (FIG. 5C). As shown in FIG. 5C, the attestation response 580 may first comprise the nonce 572 and a secure hash (such as SHA-1 or SHA-256) of the currently running task 574, which, together, may be encrypted using Ksaa 476b (the private key generated at block 415 and associated with this particular AAC 484). The attestation response 580 may further comprise the AAC 484 and attestation service identifier 473 (in some embodiments this identifier may be a part of AAC 484). At block 515, the supervisor 160 may send the attestation response 580 to the server 300.

At block 520, the method implemented by the server 300 may continue, whereby the server 300 may receive the attestation response 580 and at block 525, the server 300 may validate the digital signature 488 of the received AAC 484. In performing this validation, the server 300 may, using the attestation service identifier 473 received with attestation response 580, obtain the whole certificate chain leading to the AAC 484 and validate this chain using one of the root certificates (not shown) stored within the server 300. This chain may be received, for example, from the attestation service having the attestation service identifier 473. In some embodiments, to reduce the amount of interaction with external services, the server 300 may cache this chain for future use with AACs with the same attestation service identifier 473.

At block 530, the server 300 may obtain Kpaa 476a (the public key contained in the AAC 484), and use it to decrypt the nonce 572 and the task hash 574. At step 535, the server 300 may compare the nonce received at step 520 and decrypted at step 530 to the nonce originally sent by the server 300 at step 505. If the two nonces match, the server 300 may be assured that the other device with which it is communicating via a secure connection (i.e., the secure zone 150) is a legitimate and uncompromised secure zone 150. This is because only the supervisor 160 of a correct, uncompromised secure zone 150 possesses Ksaa 476a, the private key associated with the AAC 484, which was used to encrypt the nonce and the task hash at step 510. If the nonces do not match, the server 300 may consider the attestation process to have failed and terminate the connection.

At block 540, the server 300 may validate that a task running in the secure zone 150 of the client's computing device 120 is an acceptable task. This may be done, for example, by matching the client task hash received at step 520 and decrypted at step 530 with a list of hashes of acceptable tasks that is stored on the server 300. If the hash cannot be matched, it may be assumed that a different task from the one expected is running in the secure zone 150. While this does not necessarily mean that the secure zone 150 is compromised, the server 300 may nevertheless consider the attestation process to have failed and terminate the connection.

The overall security of the processes described with respect to FIGS. 4A and 5A may be improved even further by, for example, ensuring that the data manipulated within the blocks described with respect to these processes is not revealed to the task being attested.

The exemplary process described with respect to FIG. 5A shows one implementation by which a task running in the secure zone 150 of a computing device 120 may be remotely attested to a server 300 (i.e., one-way, device-to-server attestation). In some embodiments, however, it may be desirable to connect one computing device 120 (client peer) to another computing device 120 (server peer), and to mutually attest devices (and the tasks running on the devices), such that both tasks can verify that the other is running on a legitimate, secure physical device (i.e., a two-way, device-to-device attestation).

As mentioned above, anonymous SSL/TLS connections may be susceptible to a man-in-the-middle attack. On the other hand, unlike attestation services 330, secure zones 150 of computing devices 120 may not have certified public keys that are widely known to other devices (e.g., for privacy reasons). FIG. 7A shows an exemplary process of establishing a secure communication channel between, and performing mutual attestation by, two computing devices 120 in a peer-to-peer manner. In this process it is assumed that both client peer 760 and server peer 765 are computing devices 120 with secure zones 150, which may securely communicate with a server 300 as shown in FIG. 7B. The process of FIG. 7A may involve a method implemented by a first secure zone of the server peer 760, method implemented by a second secure zone of the client peer 765, and a method implemented by the server 300.

At block 700, the method implemented by the first secure zone of the server peer 760 may start, at which the server peer 760 may securely connect to and be attested to the server 300 using, for example, the method described with respect to FIG. 5A. At block 705, the server peer 760 may indicate to the server 300 (for example, by sending an appropriate message) that it is ready to accept connections from other devices 120 (e.g., the client peer 765).

At block 710, the method implemented by the second secure zone of the client peer 765 may start, at which the client peer 765 may securely connect to and be attested to the server 300 using, for example, the method described with respect to FIG. 5A. At block 715, the client peer 765 may indicate to the server 300 (for example, by sending an appropriate message) that it is willing to establish connections with other devices 120 (e.g., the server peer 760). It should be noted that the attestation of the server peer 760 and client peer 765 may occur in any order, and that a device 120 may act as both a server peer 760 and/or client peer 765 depending on the particular circumstances. However, before transmitting any information about server peer 760 to the client peer 765, the client peer 765 should already be attested.

If both the server peer 760 and client peer 765 are successfully attested, then, at block 720, the method implemented by the server 300 may start, at which the server 300 may transmit to the client peer 765 a ServerPeerAttest message 790 (shown in FIG. 7C). The ServerPeerAttest message 790 may contain the address 792 (e.g., an IP address or a URL) of the server peer 760, the AAC 794 of the server peer 760 (obtained by the server 300 during the attestation of the server peer, e.g., at block 520 of FIG. 5A), the AAC validation information 796 of the server peer 760 (obtained by server 300 during server peer AAC validation, e.g., at block 525 of FIG. 5A), and the AAC validation information 798 of the client peer 765 (obtained by the server 300 during the client peer AAC validation, e.g., at block 525 of FIG. 5A). In some embodiments, AAC validation information fields 796 and 798 may be optional and need not necessarily be included. In some embodiments, the method implemented by the server 300 may end after the block 720 is completed.

Because the client peer 765 may not completely trust the validation performed by the server 300, in some embodiments, at block 725, the method implemented by the client peer may continue, at which the client peer 765 may independently validate the AAC 794 of server peer 760 by, for example, using the AAC validation information 796 contained in the ServerPeerAttest message 790. If this validation is passed successfully then, at block 730, the client peer 765 may establish a secure SSL/TLS connection with the server peer 760 using a public key of the server peer 760 that may be taken from AAC 794 of the server peer 760.

Then the method implemented by the server peer may continue to block 735, at which the server peer 760 may perform an attestation of the client peer 765 and the task running on it by, for example performing steps 505-540 of FIG. 5A. To reduce interaction with third party servers, when creating the attestation response (e.g., at block 510), the supervisor 160 of the client peer 765 may add to the attestation response 580 the client AAC validation information 798 so that the server peer 760 may use it in the process of validating the client peer AAC. After the block 735 is completed, the method implemented by the server peer may end.

Finally, at block 740, the method implemented by the client peer 765 may perform an attestation of the server peer 760 and the task running on it, for example, by performing steps 505-540 of FIG. 5A. Because the client peer 765 has already received and validated the AAC 794 of the server peer 760, however, at this step the client peer 765 may merely request that the sever peer 760 provide a secure hash of the task currently running on it.

When establishing an SSL/TLS connection, the public key of the server peer is known to the client peer 765 before an SSL/TLS connection is established between the two devices (because the public key of the server peer 760 is contained in the AAC 794 of ServerPeerAttest message 790 received by the client peer 765). To prevent a potential eavesdropping party from obtaining the public key of the server peer 760 the following modification may be made to a standard SSL/TLS protocol. More particularly, instead of containing the server peer 760's true public key, the Certificate message (as defined in the Internet Engineering Task Force (IETF) Request for Comment 5246, entitled “The Transport Layer Security (TLS) Protocol Version 1.2,”) transmitted by the server peer to the client peer during the process of establishing an SSL/TLS connection may contain a “fake” certificate in the sense that it is signed with a key that is not contained in the AAC 794 of the server peer 760 or the certificate public key field is filled with the appropriate number of random bits. When the client peer 765 receives the server peer Certificate message, it may ignore the public key information contained within the Certificate message and instead use the public key information in the AAC 794 contained in the ServerPeerAttest message 790 received from the server 300. This approach allows the use of existing SSL/TLS protocols and is compatible with most of the existing Internet infrastructure (e.g., firewalls) while still addressing privacy concerns. It should be recognized that these modifications can be incorporated into any version of SSL/TLS, including any future-developed versions.

FIG. 6A shows another exemplary process by which a secure zone 150 may acquire an AAC that may be used (e.g., in accordance with the process described with respect to FIG. 5A) to attest a secure zone 150. The exemplary process shown in FIG. 6A is designed to reduce the susceptibility of the overall system to certain types of attacks, such as denial of service (DoS) attacks. The process shown in FIG. 6A may involve a method implemented by the secure zone 150 and a method implemented by the attestation service 330.

The system shown in FIG. 3, and the data structures shown in FIGS. 6B-6D, may be used in the performance of the process shown on FIG. 6A. The process and data structures described with respect to these FIGS. 6A and 6B-6D are similar to those described with respect to FIGS. 4A and 4B-4D. Those with ordinary skill in the art will understand that certain details described with respect to FIGS. 4A-D, while not repeated here, may be applicable to the present discussion of FIGS. 6A-D.

To enable the process shown in FIG. 6A, the database 303 of the attestation service 330 may store, in addition to a device identifier 310 and public key 307a, for each secure zone 150: (i) a current temporary device identifier 350 and an associated secret key 355 (FIG. 3); and (ii) a new temporary device identifier 360 and an associated secret key 365 (FIG. 3). Each temporary device identifier 350, 360 may be a one-time randomly-generated identifier, and each secret key 355, 365 may be a one-time symmetric key. These values also may be different for each attestation service 330 with which the secure zone 150 may be used.

In certain embodiments, by way of example and not limitation, an initial value of the current temporary device identifier 350 and associated secret key 355 may be generated by the secure zone 150 at manufacturing time, or may be saved into the secure zone 150 at manufacturing time. Similarly, one way by which the values of the current temporary device identifier 350 and the associated secret key 355 may be populated in the attestation service's database 303 is at manufacturing time. It will be understood, however, that any suitable method of initializing these values may be used.

At block 600 (FIG. 6A), the method implemented by the secure zone 150 may start, at which the supervisor 160 may obtain a device attestation descriptor 670 shown in FIG. 6B. By way of example and not limitation, the device attestation descriptor 670 may be received from a task while it is running within the secure zone 150, may be received at the same time that the task is loaded into the secure zone receives 150, or it may be received in any other appropriate manner or time. In some embodiments, the device attestation descriptor 670 may be received from a server 300, for example, as part of an attestation process. Regardless of how the device attestation descriptor is received, the supervisor 160 may also know the task signer with which the attestation descriptor is associated.

The device attestation descriptor 670 sent to the supervisor 160 at this block 600 may comprise one or more digital certificate Cas 672 of a suitable attestation service 330. The Cas 672 may comprise an attestation service identifier 673.

At block 605, upon receipt of the device attestation descriptor 670, the supervisor 160 may validate the Cas 672 contained in the descriptor 670. If the received Cas 672 is validated successfully, at block 610, the supervisor 160 may check whether a valid AAC that attests the secure zone 150 is already stored within AAC storage 168. If a valid AAC has been stored within AAC storage 168, the method may stop. This stored AAC then may be used (e.g., as described with respect to FIG. 5A) to attest the secure zone 150 (and, optionally, a particular task running within the secure zone 150). If an appropriate AAC is not located within AAC storage 168, however, the secure zone 150 may need to obtain an AAC from an attestation service 330.

To request an AAC from an attestation service 330, at block 615, the supervisor 160 (in conjunction with, in some embodiments, the RNG 124) may generate (i) a new asymmetric key pair, Kpaa/Ksaa 676a/b, and (ii) an AAC request 674. As shown in FIG. 6C, the AAC request 674 may comprise: (i) the temporary device identifier 350; (ii) the public key Kpaa 676a of this newly-generated key pair 676a/b; and (iii) the current time 678a (e.g., as provided by the timer 169) which may be encrypted with the temporary secret key 355. The AAC request 674 may further comprise a second field comprising the same value of current time, 678b, but which, as in the method described with respect to FIG. 4A, has been encrypted using the private key 307b of the secure zone 150. At block 620, the supervisor 160 may send the AAC request 674 to the attestation service 330 and the method implemented by the secure zone 150 may thereafter await a response.

At block 630, the method implemented by the attestation server 330 may start, whereby the attestation service 330 may receive the AAC request 674 and use the temporary device identifier received within the AAC request 674 to locate the corresponding temporary secret key within the database 303. For example, the received temporary device identifier may be compared to the stored temporary device identifier 350, and if a match is found, the corresponding temporary secret key 355 may be returned.

The process may provide for the periodic updating of the current temporary device identifier with a new temporary device identifier. In such embodiments, it is possible that the secure zone 150 and the attestation service 330 could become out of sync (due to, for example, a communication error between the two). As a result, one device could retain a temporary device identifier as the current temporary identifier, while the other may retain the same value as the new (i.e., updated) temporary identifier. Accordingly, in some embodiments, it may be desirable at this block 630 to compare the received temporary identifier to both the stored temporary device identifier 350 and the stored new temporary device identifier 360, and the secret key 355 or the secret key 365 may be returned, as appropriate.

At block 635, the attestation service 330 may decrypt the first received instance of the encrypted time 678a using the appropriate temporary secret key 355/365. If, at block 640, the decrypted time 678a is considered valid (e.g., falls within a predetermined time range), the attestation service 330 may be assured that it is communicating with a specific and valid supervisor 160. Accordingly, it will no longer be possible to mount an anonymous DoS or distributed DoS attack.

Furthermore, as all of the operations up to this block 640 have been relatively processor non-intensive, the potential for any DoS or distributed DoS attack is low. For example, it will be understood that the process of performing decryption using a symmetric key may be considerably less intensive than the decryption described in FIG. 4A at block 430, which required the decryption of the AAC request 474 using Ksasp 332b (the private key of the attestation service 330).

At block 645, the attestation service 330 may continue processing the AAC request 674, decrypting the second instance of encrypted time 678b using the device's public key 307a. At block 650, the attestation service 330 may then confirm that the two received times 678a and 678b are the same.

If the times are the same, at block 655, the attestation service 330 may additionally store the received temporary device identifier (provided within the AAC request 674, e.g., at block 615) within the database 303 as the current temporary device identifier 350. Similarly, the attestation service 330 may store the associated temporary secret key (located, e.g., at block 630) as the current temporary secret key 355. In this manner, based on a temporary device identifier actually received from the supervisor 160 the attestation service 330 may update the database 303 such that both the attestation service 330 and the secure zone 150 have the same current temporary device identifier 350 and key 355.

At block 660, the attestation service 330 may further generate a new temporary device identifier and associated temporary key and store them as the new temporary device identifier and secret key, 360 and 365, respectively.

The attestation service 330 may further, at block 663, create an AAC 684 comprising: (i) Kpaa 676a (as generated, for example, at block 615 and provided in the AAC request 674); (ii) an AAC validity period 686; and (iii) a digital signature 688, signing both Kpaa 676a and the AAC validity period 686, using Ksasa 333b. The AAC 684 also may be encrypted using the device public key 307a for transmission back to the supervisor 160.

At block 665, the AAC 684 may be sent back to the computing device 120 for storage and the method implemented by the attestation service 330 may end after the block 665 is completed. At block 667 the method implemented by the secure zone 150 may resume, at which the supervisor 160 may receive and decrypt and store the AAC 684. The method implemented by the secure zone 150 may end after the block 667 is completed.

In some embodiments, at block 665, the attestation service 330 may additionally send to the supervisor 160 the new temporary device identifier 360 and associated secret key 365. In certain embodiments, this information also may be encrypted using the device public key 307a for transmission back to the supervisor 160. In such embodiments, at block 667 the supervisor 160 may additionally receive and store the new temporary device identifier 360 and associated secret key 365 as the device ID and secret key to be used with this particular attestation service 330. Then, for the next attestation request to this attestation service 330, the supervisor 160 may supply the stored new temporary device identifier 360 and associated key 365 in the AAC request 674, such that these new values are updated within the attestation service 330 as the current device identifier and key. In this manner, each time the attestation service 330 is accessed by a particular secure zone 150, its temporary device identifier and associated key can be updated.

In some cases, however, the new temporary device identifier 360 and associated secret key 365 may not be received by the supervisor 160 at block 667, such that the temporary device identifier and associated key are not updated by the supervisor 160 following this AAC request. In such cases, the supervisor 160 could, for the next attestation request to the same attestation service 330, issue the AAC request 674 using the old temporary device identifier, which is still present in the attestation service's database 303 as the current temporary device identifier 350. As noted, at block 625, the system may be configured to compare the device identifier provided within the AAC request 674 to both the current and new temporary device identifiers, 350 and 360, respectively, to address such discrepancies.

In embodiments implementing AAC requests 674 in accordance with this FIG. 6A, if an AAC is not requested (e.g., at block 600), no processing is done within the attestation service 330. As a result, nothing, including the value of the temporary device identifiers and secret keys, may change within the database 303 until a new AAC request 674 is provided by the supervisor 160. Nevertheless, if there is a need to change the information within the database 303, the supervisor 160 may freely issue a new AAC request and is not thereafter obligated to use the results of such an AAC request.

In some embodiments according to the present disclosure, the system may be configured to support multiple processes of seeking AACs. For example, the system may support both the process shown in FIG. 4A and the process shown in FIG. 6A. In such embodiments, the process shown in FIG. 6A may be used whenever possible so as to reduce the possibility of DoS attacks, and the rate limit on such a process could be set to a relatively small value (e.g., one AAC request per second). Accordingly, in such embodiments, the method shown in FIG. 4A, which is more computationally expensive at the beginning of the process, may be reserved for situations in which a temporary device identifier stored in an attestation service's database 303 becomes out of sync with the corresponding supervisor 160, and the rate limit on this process may be set to something relatively larger (e.g., one AAC request per hour).

In one embodiment, after an AAC is obtained and associated with a specific task signer, task(s) signed by that specific task signer may request and/or receive the AAC's public key. Accordingly, the task(s) may be able to obtain an identifier for the secure zone 150 that is unique to the task signer that signed the task. In one embodiment, the AAC may include an additional unique identifier that is not the AAC's public key that may be provided to the task instead of the AAC's public key.

In some embodiments, to address privacy issues that may arise, for example, when a device 120 with a secure zone 150 is sold by a first user to a second user, the supervisor 160 may be capable of clearing the AAC storage 168, and/or capable of removing selected device/attestation service keys Kpaa/Ksaa's from the AAC storage 168 of the secure zone 150. This may result in the secure zone 150 obtaining a new identity.

Modifications to the present disclosure are possible to reduce the potential for DoS/DDoS attacks on the attestation service 330 by changing the “identity” of the secure zone 150. By way of example and not limitation, the computing device 120 and the supervisor 160 may allow clearing of the AAC storage 168 (or removing selected device/attestation service keys Kpaa/Ksaa from the AAC storage 168) only upon receipt of manually-entered user input (e.g., not automatically or via a program), and/or with a relatively slow rate limit (such as once per 5 minutes, once per hour or a few times a day). For example, if the computing device 120 is a laptop, this type of clearing may be allowed only through the BIOS setup screen during a system reboot.

Additionally, for example, the supervisor 160 may record and store the time(s) when the AAC storage 168 is cleared (or when selected device/attestation keys are removed from the AAC storage 168) and may provide this information to the task running within the secure zone 150 for use by that task and/or so the task can provide the information to the server 300 during the attestation process. This information may be useful to prevent various forms of flooding attacks. For example, by examining the information regarding when the AAC storage 168 was last cleared (which may correspond to when the secure zone's 150 identity was changed), the server 300 may recognize that a malicious user is impermissibly attempting to create additional identities to communicate with the server or trying to perform a DoS attack. In such an embodiment, the information about the time(s) that the AAC storage has been cleared may be included, for example, within the signed portion of the task attestation response 580.

To preserve as much privacy as possible while satisfying legitimate interests of task signers, in some embodiments, the information regarding the last time that the AAC storage 168 was cleared may be reported as an approximation instead of an exact time. For example, if the time since the last clearing is less than one hour, the information may be provided as a number of minutes; if the time since the last clearing is greater or equal to one hour but less than 24 hours, the information may be provided as a number of hours; if the time since the last clearing is greater or equal to 24 hours but less than 30 days, the information may be provided as a number of days; and if the time since the last clearing is greater or equal to 30 days, the information may be provided as any appropriate designation indicative of a value greater than 30 days. Other approximation schemes are also possible.

In some embodiments, if the supervisor reports the time(s) when the AAC storage is cleared and supports removing individual device/attestation service public keys Kpaa's from the AAC storage 168, then when an individual public key Kpaa from the AAC storage 168 is being removed, the supervisor 160 may leave a record of that event in the AAC storage 168. Such a record may contain the task signer identifier and a time when a respective Kpaa was returned. In such an embodiment, when reporting “the last time when AAC was cleared” (e.g., to the task or during attestation, as described above), the supervisor 160 may use the information from this record when reporting the “last time when AAC was cleared” for a specific task signer.

In some embodiments, a server 300 may be able to determine that a secure zone 150 has been compromised based on the details of the communication between the server and the task running on the secure zone, even though the task and the secure zone may have been attested at an earlier point in time. FIG. 8A depicts an exemplary process by which the server 300 may send a report to the appropriate attestation service (e.g., the attestation service 330) that the particular secure zone 150 is compromised or is otherwise untrustworthy. The process shown in FIG. 8A may involve a method implemented by the server 300 and a method implemented by the attestation server 330.

At block 800, the method implemented by the server 300 may start, at which the server 300 may receive information—or not receive information that is otherwise expected—that would otherwise cause the server to suspect that the secure zone 150 and/or the task running in that secure zone is corrupted or otherwise compromised. By way of example and not limitation, a server may know and/or expect that an already attested task should send a particular message to the server at a predefined time and/or based on a predefined trigger. If the server does not receive the expected message (or receives a different message), however, the server may assume that a different task is running in the secure zone 150 than the expected task and/or that the secure zone 150 has been compromised.

At block 805, the server 300 may transmit a compromised device notice 850 (FIG. 8B) to the appropriate attestation service 330 to remove the particular secure zone 150 from the database 303. The compromised device notice 850 may include an AAC 860 that for the compromised secure zone 150, and some additional information 870 which may serve as evidence or proof that the particular secure zone 150 has been compromised. The additional information 870 may be, for example, (a) compilable source code of the task running on the secure zone 150 and compilation instructions making it possible for the server 330 to compile the code and obtain a hash, (b) “secrets” or other information that were used to establish a secure connection between the server 300 and the secure zone 150 (for example, if an SSL connection was established using an RSA key exchange, the secrets may include a “premaster secret” or a “master secret”), (c) a transcript of the communications during which the unexpected behavior was encountered by the server 300, as well as an explanation of why the observed behavior is unexpected or inappropriate for the task that is supposed to be running within the secure zone 150, and/or (d) any other appropriate information that would allow the attestation service to evaluate whether the secure zone 150 has been compromised. The method implemented by the server 300 may end after the block 805 is completed.

At block 810, the method implemented by the attestation service 330 may start, at which the attestation service 330 may evaluate the additional information 870. For example, to evaluate the compilable source code, the session data between the task and the server may be decrypted to obtain the task hash reported by the supervisor 160 (which may have been included, for example, in the AAC sent by the secure zone 150 to the server 300 during the process of attestation), the compilable source code received as information 870 may be compiled, and the hash of the compiled code may be compared to the hash obtained in the session data. The source code received as information 870 may further be analyzed to ensure that such a task cannot produce output(s) as found in the session data.

At block 815, if the attestation service 330 determines that secure zone 150 has been compromised, then at step 820, the attestation service 330 may remove and/or delete the secure zone corresponding to the AAC 860 from the list of trusted and uncompromised secure zones 150 stored in the database 303. At optional block 825, the attestation service 330 may store the additional information 870 received with the compromised device notice 850 so that there is a record of why the reference to the particular compromised secure zone was removed from the database 303. If, at block 815, the attestation service 330 determines that the reported secure zone 150 is not necessarily compromised, then the process may end.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A computing device, comprising:
a secure zone, configured to:
execute a task, the task having executable code and data;
obtain a private key and an attestation certificate associated with the private key, the attestation certificate being received from an attestation service attesting legitimacy of the computing device;
calculate a secure hash of the task being executed;
generate a message comprising the secure hash;
sign the message with the private key; and
send the message and the attestation certificate to a second computing device in communication with the computing device.

2. The computing device of claim 1, wherein the secure zone is further configured to:
receive an attestation request from the second computing device, the attestation request comprising a nonce; and
include the received nonce in the message.

3. The computing device of claim 1, wherein the secure zone further comprises a storage storing a second private key, the second private key is associated with the secure zone, wherein to obtain the private key and the attestation certificate associated with the private key the secure zone is configure to:
securely generate a public key and the private key as a pair of asymmetric keys inside the secure zone;
sign the generated public key with the second private key;
send the signed public key to the attestation service; and
receive the attestation certificate from the attestation service.

4. The computing device of claim 3, wherein the secure zone further comprises a secure timer, and wherein the message further comprises a current time provided by the secure timer.

5. The computing device of claim 3, wherein the secure zone further comprises a non-volatile storage to store the generated private key and the received attestation certificate.

6. The computing device of claim 5, wherein the non-volatile storage stores a plurality of attestation certificates, each of the plurality of attestation certificates is issued by a different attestation service.

7. The computing device claim 3, wherein the secure zone is further configured to:
generate an attestation certificate request;
encrypt the attestation certificate request using a public key of the attestation service obtained from a digital certificate of the attestation service; and
send the attestation certificate request to the attestation service, wherein the signed public key is to be sent to the attestation service as a part of the attestation certificate request.

8. The computing device of claim 1, wherein the attestation certificate is associated with the secure zone.

9. The computing device of claim 1, wherein the attestation certificate is associated with a task signer that signs the task being executed in the secure zone.

10. The computing device of claim 1, wherein the message further comprises an attestation service identifier for the attestation service that issued the attestation certificate.

11. A method for executing a task in a secure zone of a computing device, comprising
loading the task into the secure zone and executing the task, the task having executable code and data;
obtaining a private key and an attestation certificate associated with the private key, the attestation certificate being received from an attestation service attesting legitimacy of the computing device;
calculating a secure hash of the task being executed;
generating a message comprising the secure hash;
signing the message with the private key; and
sending the message and the attestation certificate to a second computing device in communication with the computing device.

12. The method of claim 11, further comprising:
receiving attestation request from the second computing device, the attestation request comprising a nonce; and
including the received nonce in the message.

13. The method of claim 11, wherein obtaining the private key and the attestation certificate associated with the private key comprises:
securely generating a public key and the private key as a pair of asymmetric keys inside the secure zone;
signing the generated public key with a second private key stored in the secure zone, wherein the second private key is associated with the secure zone;
sending the signed public key to the attestation service; and
receiving the attestation certificate from the attestation service.

14. The method of claim 13, further comprising inserting a current time provided by a secure timer in the secure zone in the message when generating the message.

15. The method of claim 13, wherein the secure zone further comprises a non-volatile storage to store the generated private key and the received attestation certificate.

16. The method of claim 15, wherein the non-volatile storage stores a plurality of attestation certificates, each of the plurality of attestation certificates is issued by a different attestation service.

17. The method claim 13, further comprising:
generating an attestation certificate request;
encrypting the attestation certificate request using a public key of the attestation service obtained from a digital certificate of the attestation service; and
sending the attestation certificate request to the attestation service, wherein the signed public key is to be sent to the attestation service as a part of the attestation certificate request.

18. The method of claim 11, wherein the attestation certificate is associated with the secure zone.

19. The method of claim 11, wherein the attestation certificate is associated with a task signer that signs the task being executed in the secure zone.

20. The method of claim 11, wherein the message further comprises an attestation service identifier for the attestation service that issued the attestation certificate.
